(19) United States
(12) Patent Application Publication
(10) Pub. No.: US 2026/0340582 A1
(43) Pub. Date: Oct. 29, 2026

(54) Generating a Picking Sequence for Items to Minimize Distance Traveled in a Facility

(71) Applicant: Maplebear Inc., San Francisco, CA (US)

(72) Inventors: David Scott, New York, NY (US); Gregory Reda, San Francisco, CA (US); Omer Wali Ayubi, Los Angeles, CA (US); Shang Li, Short Hills, NJ (US); Kevin Charles Ryan, San Francisco, CA (US); Krishna Kumar Selvam, San Francisco, CA (US)

(21) Appl. No.: 19/192,217

(22) Filed: Apr. 28, 2025

(51) Int. Cl. G06Q 10/0875; B65G 1/137

(52) U.S. Cl. CPC G06Q 10/0875; B65G 1/1371; B65G 1/1373

(57) ABSTRACT

An online system sorts lists of items into corresponding picking orders to help minimize the picking time for finding items in a facility. To generate an optimal picking order for a list, the online system obtains a planogram of items in a facility and maps geographic locations in the planogram into a quantized set of bins. Each item in the facility is assigned to a bin. The online system pre-computes bin-to-bin distances in the facility, accounting for paths within the facility for traveling from bin to bin. For the list of items, the online system generates an item-to-item distance matrix including distances between each pair of items in the list based on the pre-computed bin-to-bin distances for corresponding bins. Based on the item-to-item distance matrix, the online system sequences items of the list based on their relative distances using one or more methods.

### BACKGROUND

Various online systems offer items for acquisition by users, with an online system receiving a selection of one or more items from a user and providing the selected one or more items to the user. Subsequently, the user receives the selected items from the online system. For example, the online system allocates an order from a user to a picker, who obtains items from a facility included in the order and delivers the obtained items to a location specified by the order.

Many online systems generate a sequence for obtaining items included in an order that is provided to a picker. For example, the online system generates a sequence specifying a relative order in which to obtain items from the facility to minimize a time spent by a picker obtaining items of the order within the facility. However, when generating a sequence for obtaining items from a facility, conventional online systems generally do not account for the distance a picker travels within the facility when obtaining items for an order.

Although an online system may obtain location information from a facility that specifies physical locations of different items within the facility, evaluating distance traveled by a picker for different relative ordering of items is time-intensive and computationally intensive. As many orders include a large number of items, generating distances between different pairs of items is time-intensive from generating the different potential pairs of items and from evaluating distances between different pairs of items based on physical locations of different items from the location data. The number of calculations for generating distances between different pairs of items in an order and evaluating different sequences of items prevents conventional online systems from evaluating distance traveled by a picker within a facility obtaining items in time intervals that would not delay pickers in obtaining items from a facility.

Existing systems that generate item picking sequences often do so without regard for the actual spatial layout of the facility in which items are located. Such systems may rely on simple item lists or relative categories that do not reflect real-world distances or obstructions. As a result, pickers may travel inefficient routes, leading to increased fulfillment times and operational inefficiencies. Attempting to compute precise distances dynamically for each new order is computationally expensive and time-consuming, particularly as the number of items and facility size increases. This lack of efficient, scalable routing methods for spatially distributed item retrieval presents a technical challenge in optimizing order fulfillment workflows.

### SUMMARY

In accordance with one or more aspects of the disclosure, an online system enables users to identify a facility and to identify one or more items to obtain from the facility. Subsequently, the online system allocates items identified by a user to a picker, who obtains the items from the facility and delivers the items to a location specified by the user. A facility may be a warehouse or another physical location including various items. The picker travels to the facility, physically obtains one or more items a user identified to the online system, and delivers the obtained items to a location specified by the user.

The online system receives location data from a facility describing a physical layout of the facility and identifying physical locations within the facility of items available from the facility. In various embodiments, the location data comprises a planogram describing a physical layout of a facility and identifying items included in different physical locations within the facility. For example, a planogram depicts positions of different aisles or other storage locations within a facility and identifies one or more items that are included in each aisle or storage location. In various embodiments, the planogram includes latitude and longitude information corresponding to different physical locations within the facility. For example, a planogram includes a set of latitudes and longitudes for different physical locations within the facility and identifies one or more items included in the physical location, allowing determination of a latitude and a longitude corresponding to different items within the facility.

To reduce data identifying physical locations within the facility, conserving storage resources used by the online system for identifying physical locations within the facility, the online system segments the location data into a plurality of bins, with each bin representing a physical area in the facility. For example, the online system segments the location data into a two-dimensional grid comprising a plurality of squares, with each square corresponding to a bin. In other embodiments, the online system segments the location data into a plurality of cells that may have different dimensions or different shapes. Hence, different bins correspond to different locations within the two-dimensional grid. Each bin corresponds to a subset of location data within boundaries specified by the coordinates of the square comprising the bin. In various embodiments the online system stores a size parameter specifying a physical width corresponding to each square and segments the location data into the plurality of squares that each have the width specified by the parameter, with each square corresponding to a different bin of the plurality.

When segmenting the location data into the plurality of bins, the online system identifies one or more bins that are unable to be traversed by a person traveling inside of the facility. For example, the online system stores an indication in association with one or more bins that are unable to be traversed by a person. In other embodiments, the online system differently distinguishes between bins corresponding to physical locations within the facility able to be traversed by a person and bins corresponding to physical locations within the facility unable to be traversed by a person. This allows the online system to identify limitations or restrictions on travel through the facility from the location data via the plurality of bins. Segmenting the location data into the plurality of bins reduces the amount of data used by the online system to represent the physical layout of the facility, reducing storage resources allocated to describing the physical location of the facility and reducing computational resources used by the online system to analyze the location data.

Additionally, the online system obtains items available from the facility and maps each item available from the facility to a corresponding bin based on the location data. In various embodiments, the location data identifies physical locations, such as a latitude and a longitude, for each item or for each category of item. The online system maps an item to a bin including the physical location identified for the item or identified for a category including the item. In various embodiments, the online system stores associations between an identifier of each item and a corresponding bin to which each item is mapped.

Additionally, the online system generates a bin-to-bin distance for each pair of bins. The bin-to-bin distance between a bin and another bin is based on a difference between a physical location corresponding to the bin and a physical location corresponding to the other bin. When generating the bin-to-bin distance for a pair of bins, the online system generates a Manhattan distance based on a coordinate pair for a bin of the pair and a coordinate pair for another bin of the pair. For example, coordinate pairs for bins comprise a latitude coordinate and a longitude coordinate, so the Manhattan distance between a bin and another bin comprises a sum of an absolute value of a difference between the latitude coordinate of the bin and the latitude coordinate of the other bin and an absolute value of a difference between the longitude coordinate of the bin and the longitude coordinate of the other bin. In various embodiments, the online system accounts for bins that are unable to be traveled by a person within the facility when generating a bin-to-bin distance. For example, the online system multiplies a Manhattan distance between a pair of bins by a multiplier based on a number of bins between the pair of bins indicated as unable to be traveled by a person to generate the bin-to-bin distance for the pair of bins. The online system stores a bin-to-bin distance in association with each pair of bins for subsequent retrieval. Predetermining and storing the bin-to-bin distances reduces an amount of latency for the online system to subsequently generate distances between different pairs of items in the facility by retrieving a predetermined bin-to-bin distance for a pair of bins corresponding to the pair of items.

With items available from the facility mapped to corresponding bins and bin-to-bin distances between each pair of bins generated and stored, the online system receives a list of items to obtain from the facility. For example, the online system receives an order from a user identifying the facility and including the list of items to obtain from the facility. However, the online system obtains the list of items in alternative or additional formats in other embodiments.

The online system maps each item of the list to a corresponding bin based on the stored mappings between items and bins. Using the bins to which each item of the list is mapped, the online system retrieves stored bin-to-bin distances for each pair of bins to which items of the list are mapped. Based on the bin-to-bin distances, the online system generates an item-to-item distance matrix including a bin-to-bin distance for each pair of items of the list. For a pair of items of the list, the item-to-item distance matrix includes a bin-to-bin distance between the bins to which each item of the pair was mapped. The online system retrieves a stored bin-to-bin distance associated with a combination of a bin to which an item of the list was mapped and an additional bin to which an additional item was mapped and stores the bin-to-bin distance in association with the pair of the item and the additional item as an entry in the item-to-item distance matrix. The item-to-item distance matrix includes a bin-to-bin distance corresponding to each pair of items of the list, so the item-to-item distance matrix includes distances between each pair of items of the list of items based on previously generated bin-to-bin distances between bins.

In some embodiments, the list of items includes one or more items that are not included in the location data, preventing the online system from mapping the one or more items to one or more corresponding bins. For example, the list of items includes a specific item that was not included in the location data, so the specific item has not been mapped to a corresponding bin. Without mapping the specific item to a bin, the online system cannot include bin-to-bin distances for pairs of the specific item and other items of the list in the item-to-item distance matrix. To account for distances between the specific item and other items of the list, the online system applies a generative model, such as a large language model (LLM), to a set of items available from the facility and to the specific item. Based on attributes of the specific item, attributes of items included in the location data, and the location data (or the mapping of items included in the location data to bins) , the generative model selects an item included in the location data having a maximum likelihood of being nearest to the specific item in the facility. Hence, the online system leverages relationships between attributes of items, or between items, learned by the generative model to select an item included in the location data most likely to be nearest to the specific item for which the online system does not have location data. Subsequently, the online system uses the bin mapped to the selected item as the bin including the specific item for generating bin-to-bin distances between the specific item and other items in the list for the item-to-item distance matrix.

The online system also generates a starting location within the facility and an ending location within the facility for a person obtaining the items of the list. In various embodiments, the online system generates the starting location as a bin including a physical location satisfying one or more criteria in the location data. Similarly, the online system generates the ending location as an additional physical location satisfying one or more criteria in the location data. For example, the online system generates the starting location as a bin including a physical location identified by the location data as an entrance to the facility and generates the ending location as an additional bin including a physical location identified by the location data as an exit from the facility or identified by the location data as a checkout location within the facility. As another example, the online system determines the starting location and the ending location as a bin including a common location identified by the location data. For example, the online system generates the starting location as a bin including a location identified by the location data as an entrance to the facility and identifies the ending location as the bin including the location identified by the location data as the entrance to the facility. In other embodiments, the online system generates the starting location or the ending location as one or bins including more physical locations satisfying other criteria from the location data.

Based on the starting location, the ending location, and the item-to-item distance matrix, the online system generates a picking sequence specifying a relative order to obtain items of the list that minimizes a total distance traveled within the facility from the starting location to the ending location while obtaining each of the list of items. The online system applies one or more methods for solving a traveling salesman problem to the item-to-item distance matrix, the starting location, and the ending location. Example methods for solving the traveling salesman problem include: a dynamic programming method (e.g., a Held-Karp algorithm), a branch-and-bound method, a progressive improvement method, one or more heuristic methods (e.g., a nearest neighbor algorithm, a match twice and stitch algorithm, a pairwise exchange algorithm, etc.). Alternative or additional methods for solving the traveling salesman problem may be used in other embodiments to generate the picking sequence minimizing a distance traveled from the starting location to the ending location while obtaining each of the list of items.

As further described above, the list may include one or more items that are not included in the location data received by the online system. For example, the list includes one or more items recently added to the facility that were not included in the previously received location data. The online system is unable to map an item that is not included in the location data to a corresponding bin, as further described above. For example, the list of items includes a specific item that was not included in the location data received by the online system. In some embodiments, the online system identifies a position of the specific item in the picking sequence by applying a generative model, such as a large language model (LLM), to a prompt including the picking sequence, the specific item, and an instruction to place the specific item in the picking sequence. In some embodiments, the generative model outputs a modified picking sequence including the specific item in a position generated by the generative model. Alternatively, the generative model outputs a position in the picking sequence for the specific item, and the online system modifies the picking sequence by inserting the specific item into the picking sequence at the position output by the generative model.

The online system transmits the picking sequence to a picker client device of a picker obtaining the list of items from the facility. Subsequently, the picker travels through the facility obtaining items in the order specified by the picking sequence while traveling from the starting location to the ending location. Using the picking sequence to obtain the items of the list reduces the distance traveled by the picker within the facility, increasing a number of lists of items that the picker subsequently obtains from the facility over time.

Segmenting the location data into the plurality of bins reduces an amount of information the online system maintains to describe the physical layout of the facility, reducing an amount of time for the online system to subsequently retrieve different portions of the physical layout of the facility. Similarly, mapping items available from the facility to bins, rather than maintaining specific physical locations for each item, preserves relative placement of different items in the facility while reducing an amount of data maintained by the online system for identifying physical locations of items within the location. Similarly, mapping items to bins reduces a number of discrete physical locations for items the online system uses for computing distances between items, as there are fewer bins than items available from the facility. This decreases an amount of computing resources for generating distances between items. Further, generating and storing bin-to-bin distances between different pairs of bins allows the online system to generate distances more efficiently between items in a list by retrieving the stored bin-to-bin distances rather than generating distances between items after receiving the list. This decreases an amount of time for the online system to generate distances between pairs of items, reducing an amount of time for the online system to generate a relative order of items in the list to decrease a distance traveled in the facility when obtaining the list of items.

Accordingly, one or more embodiments addresses the technical challenges by implementing a number of computer-implemented improvements. For example, by segmenting physical layout data into discrete bins and precomputing distances between these bins, the system significantly reduces computational demands while enabling accurate, near-instant route generation. This quantization of spatial data enables scalable optimization across many orders without reprocessing full facility maps. Furthermore, when location data is incomplete, the system leverages a lightweight generative model to infer likely item positions based on semantic relationships, ensuring that the system can continue to operate efficiently even with gaps in data. These technical innovations provide tangible improvements to data processing, memory usage, and picker efficiency, and are rooted in the practical application of computing to a real-world logistical problem.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates a flowchart of a method for generating a picking sequence for obtaining items from within a facility to minimize a distance traveled within the facility, in accordance with one or more embodiments.

FIG. 4 illustrates a process flow diagram of a method for generating a picking sequence for obtaining items from within a facility to minimize a distance traveled within the facility, in accordance with one or more embodiments.

### DETAILED DESCRIPTION

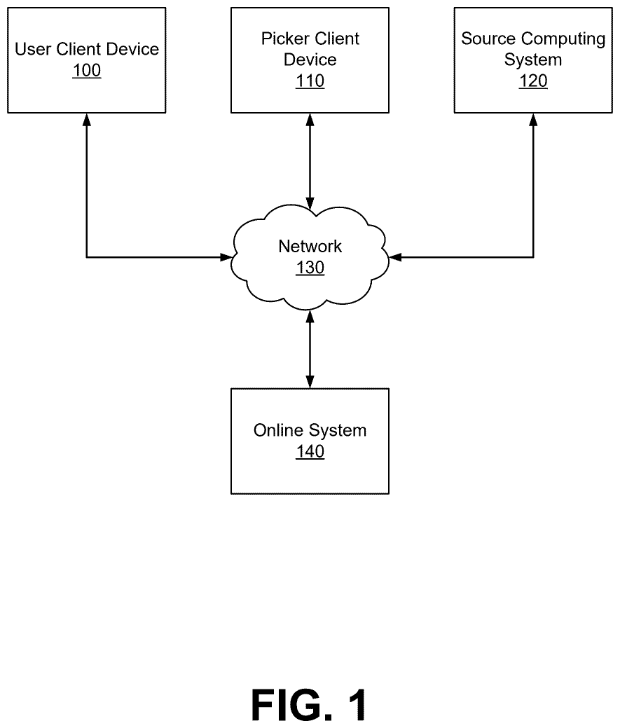

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or a desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, facility, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

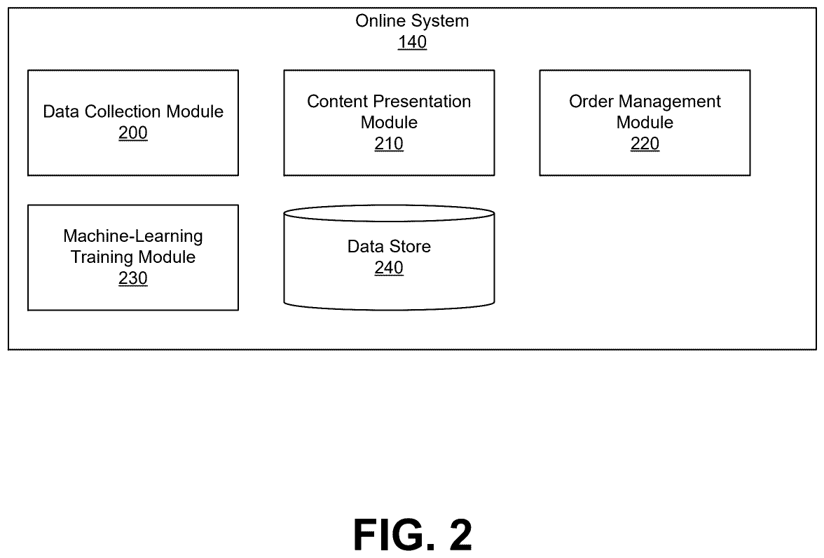

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular facility), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

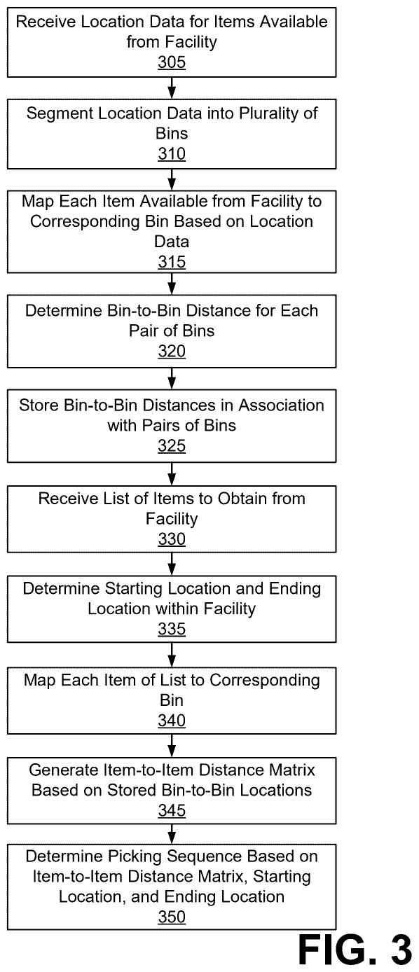

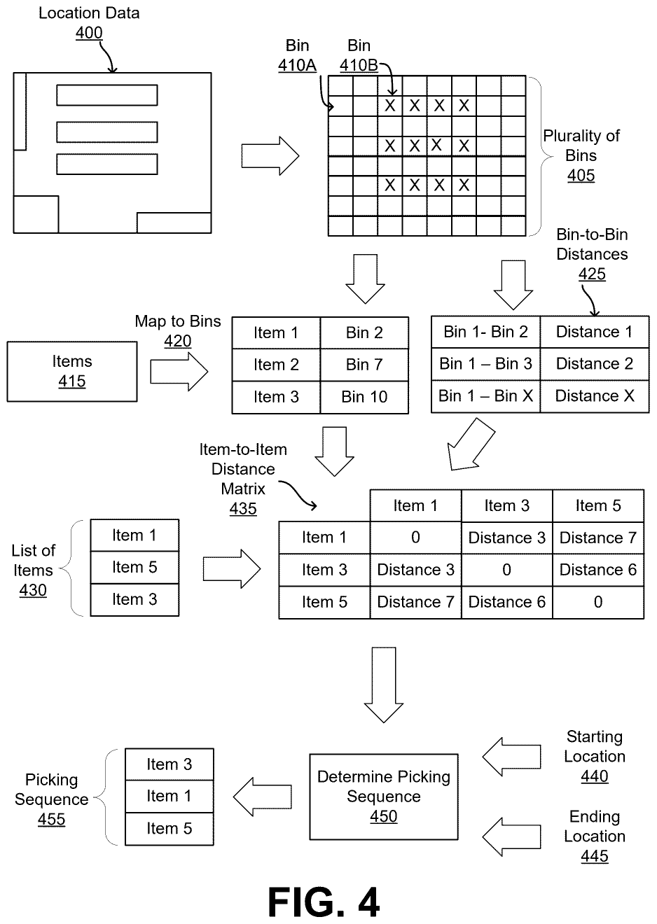

In various embodiments, the order management module 220 determines a picking sequence for a picker to obtain items in an order from a facility, such as a source. The picking sequence places items from an order in positions relative to each other that optimize a picker's acquisition of the items from a facility. As further described below in conjunction with FIGS. 3 and 4, in various embodiments the order management module 220 determines a picking sequence for items that minimizes a distance traveled by a picker within a facility when obtaining items. To determine such a picking sequence, the order management module 220 obtains location data from a facility that identifies physical areas within the facility and identifies physical locations of items within the facility. For example, the location data includes sets of latitudes and longitudes defining various physical areas within the facility and includes a latitude and a longitude for each item available from the facility.

However, location data including physical locations of individual items within a facility includes a large amount of physical locations. Determining distances between individual items in an order, or in a list of items, using physical locations of the individual items increases an amount of computations the order management module 220 performs to evaluate distances between different pairs of items and to determine how to sequence items of the list to minimize distance a picker travels between items when obtaining the items. This increases an amount of time for the order management module 220 to determine a relative order for a picker to obtain items that minimizes a distance the picker travels within the facility, delaying selection of an order, or a list, of items by a picker or delaying providing the picking sequence to a picker obtaining items.

To reduce an amount of time for determining a picking sequence that minimizes the distance a picker travels within a facility when obtaining items, the order management module 220 segments received location data into a plurality of bins. As further described below in conjunction with FIGS. 3 and 4, each bin represents a physical area within the facility based on the location data. For example, the online system 140 segments the location data into a plurality of cells based on one or more parameters (e.g., cell shape, cell width, etc.), with each cell representing a physical area within a set of coordinates defining the cell. Each cell corresponds to a bin. The order management module 220 also maps each item available from the facility to a corresponding bin. A bin corresponding to a cell comprising a physical area that includes a physical location of an item from the location data is mapped to the item. Segmenting the location data into the plurality of bins reduces a number of discrete locations that the order management module 220 associates with different items, while maintaining relative positioning of the items to each other within the facility described by the location data. This reduces data storage resources for storing physical locations within the facility.

Additionally, the order management module 220 determines a bin-to-bin distance between each pair of bins and stores a bin-to-bin distance in association with a corresponding pair of bins. This predetermines bin-to-bin distances after segmenting the location data into the plurality of bins, allowing subsequent retrieval of stored bin-to-bin distances when an order is received, rather than determination of distances between different pairs of items in the order. In response to receiving a list of items, such as an order, the order management module 220 maps each item of the list to a bin and retrieves bin-to-bin distances for each pair of items of the list, as further described below in conjunction with FIGS. 3 and 4. The order management module 220 generates an item-to-item distance matrix that includes a bin-to-bin distance corresponding to each pair of items of the list and determines the picking sequence based on a starting location within the facility, an ending location within the facility, and the item-to-item distance matrix. As further described below in conjunction with FIGS. 3 and 4, the order management module 220 applies one or more methods for solving a traveling salesman problem to the starting location within the facility, the ending location within the facility, and the item-to-item distance matrix. Using a method for solving the traveling salesman problem determines a picking sequence that specifies a relative order for a picker to obtain the items of the list that minimizes a distance traveled within the facility from the starting location to the ending location while obtaining the items, as further described below in conjunction with FIGS. 3 and 4.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

FIG. 3 is a flowchart of a method for determining a picking sequence for obtaining items from within a facility to minimize a distance traveled within the facility, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

An online system 140, such as an online concierge system, enables users to identify a facility and to identify one or more items to obtain from the facility. Subsequently, the online system 140 allocates the one or more items identified by a user to a picker, who obtains the one or more items from the facility and delivers the items to a location specified by the user. A facility may be a warehouse or another physical location including various items. The picker travels to the facility, physically obtains one or more items identified by a user to the online system 140, delivers the obtained items to a location specified by the user to the online system 140.

The online system 140 often receives a list of multiple items from a user to obtain from a facility, so the online system 140 determines a sequence for obtaining the items from the facility and provides the sequence to a picker obtaining the items. The sequence specifies a relative order for the picker to obtain the items from the facility to optimize the picker obtaining the items from the facility. Conventionally, online systems 140 determine the sequence of items to minimize an amount of time spent obtaining items within the facility. However, optimizing the time spent obtaining items often does not account for a distance the picker travels within the facility when obtaining items, which may result in the picker traveling a significant distance within the facility when obtaining items. Having a picker travel a significant distance in a facility when obtaining items decreases a number of lists of items a picker subsequently obtains from facilities for the online system 140 or decreases a likelihood of the picker subsequently obtaining additional lists of items identified by the online system 140.

To reduce distance traveled by one or more pickers within a facility when obtaining items, the online system 140 obtains 305 location data for a facility identifying physical locations within the facility of items available from the facility. In various embodiments, a source computing system 120 associated with the facility transmits the location data to the online system 140, which stores the location data in association with an identifier of the facility. However, the online system 140 may obtain 305 the location data from other sources in other embodiments.

In various embodiments, the location data comprises a planogram describing a physical layout of a facility and identifying items included in different physical locations within the facility. For example, a planogram depicts positions of different aisles or other storage locations within a facility and identifies one or more items that are included in each aisle or storage location. In various embodiments, the planogram includes latitudes and longitudes corresponding to different physical locations within the facility. For example, a planogram includes a set of latitudes and longitudes defining a physical location within the facility and identifies one or more items included in the physical location. The location data includes different sets of latitudes and longitudes for different items or for different categories of items in various embodiments. This allows determination of a latitude and a longitude corresponding to different items included in the facility. The online system 140 stores associations between various items available from the facility and corresponding physical locations within the facility in various embodiments. For example, the online system 140 stores an association between an identifier of an item and a latitude and a longitude of a physical location within the facility including the item from the location data. In various embodiments, the online system 140 determines and stores a latitude and a longitude associated with each of at least a set of items available from the facility or associated with each item available from the facility.

The location data identifies one or more physical locations in the facility that are unable to be traversed by a person, such as a picker, in various embodiments. For example, the location data identifies physical locations corresponding to physical structures in the facility, such as aisles or physical display stands, obstructing movement within the facility. This allows the location data to account for how a person, such as a picker, physically navigates through the facility to obtain items, which accurately represents the physical layout of the facility for traveling through the facility, such as when obtaining items from within the facility.

The online system 140 segments 310 the location data into a plurality of bins, with each bin representing a physical area in the facility. For example, the online system 140 segments 310 the location data into a two-dimensional grid, with different bins corresponding to different squares of the two-dimensional grid. Hence, each bin corresponds to a subset of location data within boundaries specified by coordinates of the bin (e.g., within a square of a two-dimensional grid based on the location data). In some embodiments, the online system 140 stores a size parameter specifying a physical width of each square of a two-dimensional grid and segments 310 the location data into a plurality of squares that each have a width specified by the size parameter, with each square corresponding to a bin. When segmenting 310 the location data into bins, the online system 140 identifies one or more bins that are unable to be traversed, so the bins represent the ability of a person to navigate through the facility. Hence, each bin corresponds to a specific physical area bounded by coordinates of physical locations in the facility. Segmenting the location data into the plurality of bins reduces an amount of data the online system 140 uses to represent the physical layout of the facility to subsequently process. Reducing the location data to the plurality of bins also reduces computational resources used by the online system 140 when analyzing the location data, which also reduces an amount of time for the online system 140 to analyze the location data.

The online system 140 also maps 315 each item available from the facility to a corresponding bin based on the location data for each item. As further described above, each bin corresponds to a different subset of location data. The online system 140 retrieves physical coordinates of an item associated with an identifier of the item and maps 315 the item to a bin corresponding to a subset of location data including the physical coordinates of the item. For example, each bin corresponds to a range of latitudes and a range of longitudes, and the online system 140 maps 315 an item to a bin corresponding to a range of latitudes and a range of longitudes including the latitude and the longitude associated with the identifier of the item. Multiple items may be mapped 315 to a single bin in various embodiments. The online system 140 stores an identifier of a bin in association with an identifier of an item mapped to the bin in various embodiments. For example, the online system 140 stores an identifier of a facility in association with identifiers of each item available from the facility, with each identifier of an item associated with an identifier of a corresponding bin to which each item available from the facility was mapped 315. This maps 315 each item available from the facility to a discrete set of bins, rather than to specific physical coordinates specified by the location data, reducing the amount of data the online system 140 stores to identify physical locations of items in the facility. Further, mapping 315 items to a discrete set of bins reduces a number of different physical locations that the online system 140 maintains for items available from the facility, reducing the number of different physical locations that the online system 140 subsequently analyzes or processes, conserving computing resources used by the online system 140 when analyzing locations of items within the facility.

For each pair of bins segmented 310 from the location data, the online system 140 determines 320 a bin-to-bin distance between a bin of the pair and another bin of the pair. The online system 140 stores 325 a bin-to-bin distance in association with a pair of bins for subsequent retrieval. The bin-to-bin distance between a pair including a bin and another bin is based on a difference between a physical location corresponding to the bin of the pair and the physical location corresponding to the other bin of the pair. When determining the bin-to-bin distance for a pair of bins including a bin and another bin, the online system 140 determines 320 a Manhattan distance based on a coordinate pair for the bin of the pair and a coordinate pair for the other bin of the pair in various embodiments. The Manhattan distance between a pair of bins comprises a sum of an absolute value of difference between a first value in the coordinate pair for the bin of the pair and a first value in the coordinate pair for the other bin of the pair and an absolute value of difference between a second value in the coordinate pair for the bin of the pair and a second value in the coordinate pair for the other bin of the pair. In various embodiments, a coordinate pair for a bin comprises a latitude coordinate and a longitude coordinate, so the Manhattan distance between a bin and another bin comprises a sum of an absolute value of a difference between the latitude coordinate of the bin of the pair and the latitude coordinate of the other bin of the pair and an absolute value of a difference between the longitude coordinate of the bin of the pair and the longitude coordinate of the other bin of the pair. Determining 320 a Manhattan distance between a pair of bins results in a bin-to-bin distance that more accurately reflects a likely pattern of movement through the facility by a person relative to alternative types of distances. However, in other embodiments, the online system 140 determines 320 alternative types of distance as a bin-to-bin distance between a pair of bins. Further, determining 320 a bin-to-bin distance leverages the more coarse location information represented by the bins rather than individual location information for specific items from the location data to reduce an amount of processing to determine 320 distances between locations of various items in the facility.

When determining 320 a bin-to-bin distance for a pair of bins, the online system 140 accounts for bins identified as unable to be traversed by a person, so a bin-to-bin distance reflects a physical distance traveled by a person within the facility from bin to bin. For example, the online system 140 determines 320 a bin-to-bin distance for a pair of bins based on a path between a bin of the pair and another bin of the pair that avoids one or more bins identified as unable to be traversed by a person. In various embodiments, the online system 140 determines 320 a bin-to-bin distance for a pair of bins based on a Manhattan distance between the bins scaled by a multiplier that is based on a number of bins identified as unable to be traversed by a person between the bin of the pair and the other bin of the pair. This allows the bin-to-bin distance determined 320 for a pair of bins to account for one or more physical areas within the facility that a person is unable to traverse when traveling from a bin of the pair to the other bin of the pair.

In various embodiments, the system implements a hybrid physical-topological model that combines geometric bin-based distances with learned traversability patterns. Unlike traditional approaches that rely purely on physical coordinates or purely on time-based measurements, this hybrid approach may incorporate actual movement patterns observed within the facility. The system may analyze historical picker movement data to identify common paths, bottlenecks, or shortcuts that deviate from simple Manhattan distances. These learned traversal patterns may be integrated into the bin-to-bin distance calculations as multipliers that reflect real-world navigation constraints beyond what can be inferred from the physical layout alone.

After mapping 315 items available from the facility to bins and storing 325 the bin-to-bin distance between each pair of bins, the online system 140 receives 330 a list of items to obtain from the facility. For example, the online system 140 receives 330 an order from a user of the online system 140 that identifies the facility that includes a list of items to obtain from the facility. In other embodiments, the online system 140 receives 330 the of list of items to obtain from the facility in another format or in an alternative format.

The online system 140 determines 335 a starting location for obtaining the list of items within the facility and an ending location for obtaining the list of items within the facility based on the location data. For example, the online system 140 determines a starting location as a physical location of the facility identified as an entrance to the facility from the location data and determines 335 a starting location as a bin including the physical location identified as the entrance to the facility. Similarly, the online system 140 determines an ending location as a physical location of the facility identified as an exit from the facility or identified as a checkout location of the facility from the location data and determines 335 the ending bin as a bin including the physical location identified as the exit or identified as the checkout location. In another example, the starting location comprises a bin including a location satisfying one or more criteria, while the ending location comprises an alternative bin including a location satisfying one or more alternative criteria. Alternatively, the online system 140 identifies a common location satisfying one or more criteria and determines 335 the starting location and the ending location as a bin including the common location. For example, the online system 140 determines 335 the starting location and the ending location as a bin including a location identified as the entrance to the facility, indicating a person ends travelling through the facility at the same location where the person entered the facility. In other embodiments, the online system 140 determines 335 the starting location and determines 335 the ending location as bins including physical locations for which the location data includes identification or classification information satisfying different or additional criteria.

Based on the stored mapping of items available from the facility to bins, the online system 140 maps 340 each item of the list to a corresponding bin. As further described above, each bin corresponds to a physical area within the facility, so mapping 340 each item of the list to a corresponding bin identifies physical areas within the facility including each item of the list. Based on the stored bin-to-bin distances between each pair of bins, the online system 140 generates 345 an item-to-item distance matrix including a bin-to-bin distance for each pair of items of the list. For a pair of bins each associated with a different item of the list, the online system 140 retrieves a bin-to-bin distance stored 325 in association with the pair of bins and includes the retrieved bin-to-bin distance in the item-to-item distance matrix. Hence, the item-to-item distance matrix includes distances between each pair of items of the list of items based on previously determined bin-to-bin distances between pairs bins. Leveraging the stored bin-to-bin distances reduces an amount of time for the online system 140 to determine distances between each pair of items in the list by leveraging the previously determined bin-to-bin distances rather than individually determining distances between each pair of items of the list from the location data.

In some embodiments, the list of items includes one or more items that are not included in the location data, so the online system 140 has not mapped those items to a bin. For example, the list of items includes a specific item that was not included in the location data received 305 by the online system 140. Because the specific item was not included in the location data, the online system 140 is unable to map the specific item to a bin, preventing the online system 140 from including bin-to-bin distances previously determined based on a bin including the specific item when generating 345 the item-to-item distance matrix for the list of items. To determine one or more bin-to-bin distances corresponding to the specific item not included in the location data, in various embodiments, the online system 140 applies a generative model, such as a large language model (LLM), to a set of items available from the facility and to the specific item. For example, the online system applies a generative model to a prompt including a name of the specific item, names of each of a set of items included in the location data, the mapping of items to bins or the received location data, and an instruction to select an item nearest to the specific item based on the location data or based on the mapping of items to bins. Based on relationships between words or phrases learned during a pretraining process, the generative model selects an item for which the online system 140 has location data, or having an associated bin, having a maximum likelihood of being nearest to the specific item in the facility. In some embodiments, the prompt further includes attributes of the specific item and attributes of items included in the location data, and the generative model selects the item for which the online system 140 has location data (or an associated bin) having a maximum likelihood of being nearest to the specific item in the facility based on similarities between attributes of the specific item and attributes of items included in the location data. This leverages relationships learned by the generative model to identify an item included in the location data that is most likely to be nearest to the specific item for which the online system 140 does not have location data.

The online system 140 determines a bin mapped 315 to the item selected by the generative model and uses the bin mapped to the item selected by the generative model as the bin including the specific item. This allows the online system 140 to use the bin for the item selected by the generative model as a proxy for a location of the specific item within the facility. Based on the bin mapped to the item selected by the generative model, the online system 140 obtains bin-to-bin distances for each pair of the specific item and other items of the plurality using the bin mapped to the item selected by the generative model as the bin for the specific item. Hence, entries in the item-to-item distance matrix for the specific item are based on the bin of the item selected by the generative model, allowing the item-to-item distance matrix to include bin-to-bin distances for pairs of items that include the specific item that was not included in the location data.

Based on the item-to-item distance matrix, the starting location, and the ending location, the online system 140 determines 350 a picking sequence for obtaining the list of items from the facility. The picking sequence specifies relative order in which a person (e.g., a picker) obtains the items of the plurality from the facility that minimizes a total distance the person travels in the facility from the starting location to the ending location while obtaining each of the list of items. In various embodiments, the online system 140 determines 350 the picking sequence by applying one or more methods for solving a traveling salesman problem to the starting location, the ending location, and the item-to-item distance matrix. For a list of destinations, a starting point, and an ending point, solving the traveling salesman problem determines an order for visiting the destinations beginning from the starting point and ending at the ending point that visits each destination once while minimizing a total distance traveled from the starting point to the ending point. Different methods for solving the traveling salesman problem may be applied to the starting location, the ending location, and the item-to-item distance matrix in various embodiments. Example methods for solving the traveling salesman problem include: a dynamic programming method (e.g., a Held-Karp algorithm), a branch-and-bound method, a progressive improvement method, one or more heuristic methods (e.g., a nearest neighbor algorithm, a match twice and stitch algorithm, a pairwise exchange algorithm, etc.). Alternative or additional methods for solving the traveling salesman problem may be used in other embodiments to determine 350 the picking sequence minimizing a distance traveled from the starting location to the ending location while obtaining each of the list of items.

In some embodiments, the list of items includes one or more items that are not included in the location data. The items not included in the location data are not mapped 315 to a bin by the online system 140. For example, the list of items includes a specific item that was not included in the location data received 305 by the online system 140. The online system 140 leverages a generative model, such as a large language model (LLM), to determine a position of the specific item in the picking sequence. For example, the online system 140 generates a prompt including the picking sequence, the specific item, and an instruction to place the specific item in the picking sequence. In various embodiments, the prompt includes names of each item in the picking sequence and a name of the specific item, so the generative model leverages relationships between words or phrases learned during a pretraining process to determine similarities between the name of the specific item and the names of the items in the picking sequence to determine a position in the picking sequence for the specific item. For example, the generative model outputs a modified picking sequence including the specific item in a position determined by the generative model. Alternatively, the generative model outputs a position in the picking sequence for the specific item, and the online system 140 inserts the specific item into the picking sequence at the position output by the generative model.

The picking sequence specifies an order in which a user, such as a picker, obtains the items from within the facility. Hence, the picking sequence minimizes a distance the user travels within the facility when obtaining the list of items from the facility. In various embodiments, the online system 140 transmits the picking sequence to a picker client device 110 for presentation to a picker obtaining the list of items from the facility. The online system 140 may transmit the picking sequence in response to receiving a specific input from the picker client device 110, such as an input of the picker selecting the list of items to obtain.

FIG. 4 is a process flow diagram of a method for determining a picking sequence for obtaining items from within a facility to minimize a distance traveled within the facility, in accordance with some embodiments. As further described above in conjunction with FIG. 3, the online system 140 enables users to identify a facility and to identify one or more items to obtain from the facility. Subsequently, the online system 140 allocates items identified by a user to a picker, who obtains the items from the facility and delivers the items to a location specified by the user. A facility may be a warehouse or another physical location including various items. The picker travels to the facility, physically obtains one or more items a user identified to the online system 140, and delivers the obtained items to a location specified by the user.

As further described above in conjunction with FIG. 3, the online system 140 receives location data 400 from a facility describing a physical layout of the facility and identifying physical locations within the facility of items available from the facility. In various embodiments, the location data comprises a planogram describing a physical layout of a facility and identifying items included in different physical locations within the facility. For example, a planogram depicts positions of different aisles or other storage locations within a facility and identifies one or more items that are included in each aisle or storage location. In various embodiments, the planogram includes latitude and longitude information corresponding to different physical locations within the facility. For example, a planogram includes a set of latitudes and longitudes for different physical locations within the facility and identifies one or more items included in the physical location, allowing determination of a latitude and a longitude corresponding to different items within the facility.

To reduce data identifying physical locations within the facility, conserving storage resources used by the online system 140 for identifying physical locations within the facility, the online system 140 segments the location data 400 into a plurality 405 of bins, with each bin 410A, 410B (also referred to individually and collectively using reference number 410) representing a physical area in the facility. For example, the online system 140 segments the location data 400 into a two-dimensional grid comprising a plurality of squares, with each square corresponding to a bin 410. In other embodiments, the online system 140 segments the location data 400 into a plurality of cells that may have different dimensions or different shapes. Hence, different bins 410 correspond to different locations within the two-dimensional grid. Each bin 410 corresponds to a subset of location data within boundaries specified by coordinates of the square comprising the bin 410. As further described above in conjunction with FIG. 3, in various embodiments the online system 140 stores a size parameter specifying a physical width corresponding to each square and segments the location data 400 into the plurality of squares that each have the width specified by the parameter, with each square corresponding to a different bin 410 of the plurality 405.

When segmenting the location data 400 into the plurality 405 of bins, the online system 140 identifies one or more bins 410 that are unable to be traversed by a person traveling inside of the facility. For example, the online system 140 stores an indication in association with one or more bins 410 that are unable to be traversed by a person. In the example of FIG. 4, the online system 140 stores an indication that bin 410B is unable to be traversed by a person within the facility. However, the online system 140 but does not store the indication in association with bin 410A, indicating that bin 410A is capable of being traversed by the user within the facility. In other embodiments, the online system 140 differently distinguishes between bins 410 corresponding to physical locations within the facility able to be traversed by a person and bins 410 corresponding to physical locations within the facility unable to be traversed by a person. This allows the online system 140 to identify limitations or restrictions on travel through the facility from the location data 400 via the plurality 405 of bins 410. Segmenting the location data into the plurality of bins reduces the amount of data used by the online system 140 to represent the physical layout of the facility, reducing storage resources allocated to describing the physical location of the facility and reducing computational resources used by the online system 140 to analyze the location data 400.

In some embodiments, the system may implement variable-resolution spatial quantization that dynamically adjusts bin size based on item density within different regions of the facility. Areas with high item density (such as popular product sections) may be segmented into smaller, more granular bins to maintain picking precision, while areas with sparse item placement may use larger bins to conserve computational resources. This multi-resolution binning approach may adapt over time as inventory placement changes, ensuring optimal balance between computational efficiency and route optimization accuracy without requiring manual reconfiguration of the binning parameters.

Additionally, the online system 140 obtains items 415 available from the facility and maps 420 each item available from the facility to a corresponding bin based on the location data 400. In various embodiments, the location data 400 identifies physical locations, such as a latitude and a longitude, for each item 415 or for each category of item. The online system 140 maps 420 an item 415 to a bin 410 including the physical location identified for the item 415 or identified for a category including the item. As shown in the example of FIG. 4, the online system 140 stores associations between an identifier of each item 415 and a corresponding bin to which each item 415 is mapped 420. In the example of FIG. 4, the item of “item 1” is associated with location data that is included in “bin 2,” so the online system 140 maps 420 “item 1” to “bin 2” and stores an association between “item 1” and “bin 2.” Similarly, the online system 140 stores associations between each item 415 available from the facility and a bin including a physical location associated with the item 415 based on the physical locations of items from the location data 400.

In one or more embodiments, the system may implement a machine learning component that continuously refines the bin mapping based on picking outcomes. Rather than maintaining static mappings between items and bins, the system may track the actual locations where items were found by pickers and use this feedback to adjust item-to-bin mappings over time. This adaptive mapping approach may account for subtle shifts in item placement, seasonal reorganizations, or other factors that cause items to be found in locations that differ from their official planogram positions. The system may use these learned adjustments to generate more accurate picking sequences that reflect where items are actually found rather than where they are supposed to be according to the facility layout data.

Additionally, the online system 140 determines a bin-to-bin distance 425 for each pair of bins. The bin-to-bin distance between a bin 410 and another bin 410 is based on a difference between a physical location corresponding to the bin 410 and a physical location corresponding to the other bin 410. When determining the bin-to-bin distance 425 for a pair of bins 410, the online system 140 determines a Manhattan distance based on a coordinate pair for a bin 410 of the pair and a coordinate pair for another bin 410 of the pair, as further described above in conjunction with FIG. 3. For example, coordinate pairs for bins 410 comprise a latitude coordinate and a longitude coordinate, so the Manhattan distance between a bin 410 and another bin 410 comprises a sum of an absolute value of a difference between the latitude coordinate of the bin 410 and the latitude coordinate of the other bin 410 and an absolute value of a difference between the longitude coordinate of the bin 410 and the longitude coordinate of the other bin 410. The online system 140 stores a bin-to-bin distance 425 in association with each pair of bins 410 for subsequent retrieval. Predetermining and storing the bin-to-bin distances 425 reduces an amount of latency for the online system 140 to subsequently determine distances between different pairs of items in the facility by retrieving a predetermined bin-to-bin distance 425 for a pair of bins corresponding to the pair of items.

In various embodiments, the bin-to-bin distances may incorporate temporal factors beyond pure spatial distance. The system may maintain a temporal coefficient for different facility regions that reflects the average time required to navigate that region at different times of day, days of week, or seasons. For example, certain aisles may experience predictable congestion patterns during specific time periods. By incorporating these temporal coefficients into the bin-to-bin distance calculations, the picking sequence may be optimized not just for spatial distance but for actual traversal time, which may result in different optimal sequences depending on when the picking occurs.

With items 415 available from the facility mapped 420 to corresponding bins 410 and bin-to-bin distances 425 between each pair of bins 410 determined and stored, the online system 140 receives a list 430 of items to obtain from the facility. For example, the online system 140 receives an order from a user identifying the facility and including the list 430 of items to obtain from the facility. However, the online system 140 obtains the list 430 of items in alternative or additional formats in other embodiments.

The online system 140 maps each item of the list 430 to a corresponding bin 410 based on the stored mappings between items and bins 410. Using the bins 410 to which each item of the list 430 is mapped, the online system 140 retrieves stored bin-to-bin distances 425 for each pair of bins 410 to which items of the list 430 are mapped. Based on the bin-to-bin distances 425, the online system 160 generates an item-to-item distance matrix 435 including a bin-to-bin distance 425 for each pair of items of the list 430. For a pair of items of the list 430, the item-to-item distance matrix 435 includes a bin-to-bin distance 425 between the bins to which each item of the pair was mapped. The online system 140 retrieves a stored bin-to-bin distance 425 associated with a combination of a bin to which an item of the list 430 was mapped 420 and an additional bin to which an additional item was mapped 420 and stores the bin-to-bin distance 425 in association with the pair of the item and the additional item as an entry in the item-to-item distance matrix 435. For example, in FIG. 4, “item 1” is mapped to “bin 2,” and “item 3” is mapped to “bin 10,” so the item-to-item distance matrix 435 includes “distance 3” in association with a pair including “item 1” and “item 3,” with “distance 3” comprising a bin-to-bin distance 425 between “bin 2” and “bin 10.” The item-to-item distance matrix 435 includes a bin-to-bin distance 425 corresponding to each pair of items of the list 430, so the item-to-item distance matrix 435 includes distances between each pair of items of the list 430 of items based on previously determined bin-to-bin distances 425 between bins.

In some embodiments, the list 430 of items includes one or more items that are not included in the location data 400, preventing the online system 140 from mapping 420 the one or more items to one or more corresponding bins 410. For example, the list 430 of items includes a specific item that was not included in the location data 400, so the specific item has not been mapped 420 to a corresponding bin 410. Without mapping 420 the specific item to a bin 410, the online system 140 cannot include bin-to-bin distances 425 for pairs of the specific item and other items of the list 430 in the item-to-item distance matrix 435. To account for distances between the specific item and other items of the list 430, the online system 140 applies a generative model, such as a large language model (LLM), to a set of items available from the facility and to the specific item, as further described above in conjunction with FIG. 3. Based on attributes of the specific item, attributes of items included in the location data 400, and the location data 400 (or the mapping of items included in the location data 400 to bins 410), the generative model selects an item included in the location data 400 having a maximum likelihood of being nearest to the specific item in the facility. Hence, the online system 140 leverages relationships between attributes of items, or between items, learned by the generative model to select an item included in the location data 400 most likely to be nearest to the specific item for which the online system 140 does not have location data. Subsequently, the online system 140 uses the bin 410 mapped 420 to the selected item as the bin 410 including the specific item for determining bin-to-bin distances 425 between the specific item and other items in the list 430 for the item-to-item distance matrix 435, as further described above in conjunction with FIG. 3.

The online system 140 also determines a starting location 440 within the facility and an ending location 445 within the facility for a person obtaining the items of the list 430. In various embodiments, the online system 140 determines the starting location 440 as a bin including a physical location satisfying one or more criteria in the location data 400. Similarly, the online system 140 determines the ending location 445 as an additional physical location satisfying one or more criteria in the location data 400. For example, the online system 140 determines the starting location 440 as a bin including a physical location identified by the location data 400 as an entrance to the facility and determines the ending location 445 as an additional bin including a physical location identified by the location data 400 as an exit from the facility or identified by the location data 400 as a checkout location within the facility. As another example, the online system 140 determines the starting location 440 and the ending location 445 as a bin including a common location identified by the location data 400. For example, the online system 140 determines the starting location 440 as a bin including a location identified by the location data 400 as an entrance to the facility and identifies the ending location 445 as the bin including the location identified by the location data 400 as the entrance to the facility. In other embodiments, the online system 140 determines the starting location 440 or the ending location 445 as one or bins including more physical locations satisfying other criteria from the location data 400.

Based on the starting location 440, the ending location 445, and the item-to-item distance matrix 435, the online system 140 determines 450 a picking sequence 455 specifying a relative order to obtain items of the list 430 that minimizes a total distance traveled within the facility from the starting location 440 to the ending location 445 while obtaining each of the list 430 of items. As further described above in conjunction with FIG. 3, the online system 140 applies one or more methods for solving a traveling salesman problem to the item-to-item distance matrix 435, the starting location 440, and the ending location 445. A solution to the traveling salesman problem provides an order in which a person obtains each item of the list 430 starting from the starting location 440 and ending at the ending location 445 that minimizes a distance traveled within the facility. Hence, applying a method for solving the traveling salesman problem to the item-to-item distance matrix 435, the starting location 440, and the ending location 445 determines a relative order for obtaining the items of the list 430 that minimizes distance traveled within the facility between the starting location 440 and the ending location 445 while obtaining the list 430 of items. Different methods for solving the traveling salesman problem may be applied to the item-to-item distance matrix 435, the starting location 440, and the ending location 445 to determine 450 the picking sequence 455 that specifies the order for obtaining the items of the list 430 that minimizes the distance traveled by a person within the facility from the starting location 440 to the ending location 445 while obtaining each item of the list 430 in various embodiments. In the example of FIG. 4, the picking sequence 455 determines a picking sequence 455 of “item 3,” “item 1,” and “item 5” for the list 430 of items. Hence, obtaining “item 3” then “item 1,” followed by “item 5,” minimizes a distance a user travels within the facility when obtaining the list 430 of items.

As further described above, the list 430 may include one or more items that are not included in the location data 400 received by the online system 140. For example, the list 430 includes one or more items recently added to the facility that were not included in the previously received location data 400. The online system 140 is unable to map 420 an item that is not included in the location data 400 to a corresponding bin 410, as further described above. For example, the list 430 of items includes a specific item that was not included in the location data 400 received by the online system 140. In some embodiments, the online system 140 determines a position of the specific item in the picking sequence 455 by applying a generative model, such as a large language model (LLM), to a prompt including the picking sequence 455, the specific item, and an instruction to place the specific item in the picking sequence. In some embodiments, the generative model outputs a modified picking sequence including the specific item in a position determined by the generative model. Alternatively, the generative model outputs a position in the picking sequence for the specific item, and the online system 140 modifies the picking sequence 455 by inserting the specific item into the picking sequence 455 at the position output by the generative model.

In various embodiments, the system implements context-aware optimization that considers the physical characteristics of the items being picked when generating the picking sequence. Beyond mere distance minimization, the picking sequence may account for item fragility, weight, size, temperature requirements, or stacking constraints. For example, heavier items may be sequenced earlier in the picking route to form a stable base in the picker's cart, while fragile items may be sequenced later. The system may apply weighted constraints to the traveling salesman problem that balance pure distance optimization against these practical picking considerations, resulting in sequences that minimize both travel distance and the likelihood of product damage or picker strain.

The online system 140 transmits the picking sequence 455 to a picker client device 110 of a picker obtaining the list 430 of items from the facility. Subsequently, the picker travels through the facility obtaining items in the order specified by the picking sequence 455 while traveling from the starting location 440 to the ending location 445. Using the picking sequence 455 to obtain the items of the list 430 reduces a distance traveled by the picker within the facility, increasing a number of lists of items that the picker subsequently obtains from the facility over time.

Segmenting the location data 400 into the plurality 405 of bins 410 reduces an amount of information the online system 140 maintains to describe the physical layout of the facility, reducing an amount of time for the online system 140 to subsequently retrieve different portions of the physical layout of the facility. Similarly, mapping items 415 available from the facility to bins 410, rather than maintaining specific physical locations for each item, preserves relative placement of different items in the facility while reducing an amount of data maintained by the online system 140 for identifying physical locations of items within the location. Similarly, mapping items 415 to bins 410 reduces a number of discrete physical locations for items the online system 140 uses for computing distances between items, as there are fewer bins 410 than items 415 available from the facility. This decreases an amount of computing resources for determining distances between items 415. Further, determining and storing bin-to-bin distances between different pairs of bins allows the online system 140 to determine distances more efficiently between items in a list 430 by retrieving the stored bin-to-bin distances rather than determining distances between items after receiving the list 430. This decreases an amount of time for the online system 140 to determine distances between pairs of items, reducing an amount of time for the online system to determine a relative order of items in the list 430 to decrease a distance traveled in the facility when obtaining the list 430 of items.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that are issued on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
obtaining, at the computer system, location data identifying physical locations within a facility of items available from the facility;
segmenting the location data into a plurality of bins, each bin representing a physical area in the facility;
mapping each item available from the facility to a corresponding bin based on the location data for each item and the plurality of bins;
generating a bin-to-bin distance for each pair of bins based on the location data;
storing the bin-to-bin distance for each pair of bins;
receiving a list of items to obtain from the facility at the computer system;
generating a starting location within the facility and an ending location within the facility;
generating an item-to-item distance matrix for the list of items, the item-to-item distance matrix including a bin-to-bin distance for each pair of items of the list of items, the bin-to-bin distance for an item and an additional item comprising a stored bin-to-bin distance for a bin including the item and a bin including the additional item; and
generating a picking sequence for obtaining the list of items based on the item-to-item distance matrix based on the item-to-item distance matrix, the starting location, and the ending location, the picking sequence specifying an order to obtain the items of the plurality that minimizes a total distance traveled within the facility from the starting location to the ending location while obtaining each of the list of items.

2. The method of claim 1, wherein generating the bin-to-bin distance for each pair of bins based on the location data comprises:
generating a two-dimensional coordinate system, with each bin corresponding to a coordinate pair in the two-dimensional coordinate system; and
generating a bin-to-bin distance for a pair of bins as a Manhattan distance based on a coordinate pair for a bin of the pair and a coordinate pair for another bin of the pair.

3. The method of claim 1, wherein one or more bins are identified as being unable to be traversed by a person, and wherein the bin-to-bin distance for a pair of bins based on the location data comprise a path between a bin of the pair and another bin of the pair that avoids one or more bins identified as being unable to be traversed by the person.

4. The method of claim 3, wherein generating the bin-to-bin distance for each pair of bins based on the location data comprises:
generating a two-dimensional coordinate system, with each bin corresponding to a coordinate pair in the two-dimensional coordinate system; and
generating a bin-to-bin distance for a pair of bins as a product of a multiplier based on a number of bins between a bin of the pair and an additional bin of the pair identified as unable to be traversed by a person and a Manhattan distance based on a coordinate pair for the bin of the pair and a coordinate pair for the additional bin of the pair.

5. The method of claim 1, wherein generating the picking sequence for obtaining the list of items based on the item-to-item distance matrix comprises:
generating a specific item of the plurality is not associated with at least one bin by the computing system;
applying a generative model to a prompt including the picking sequence, the specific item, and an instruction to place the specific item in the picking sequence; and
generating the picking sequence so the specific item has a position in the picking sequence that was output by the generative model.

6. The method of claim 1, wherein generating the picking sequence for obtaining the list of items based on the item-to-item distance matrix comprises:
determining that a specific item of the plurality is not associated with at least one bin by the computing system;
applying a generative model to a prompt including the picking sequence, the specific item, and an instruction to place the specific item in the picking sequence; and
modifying the picking sequence to include the specific item has a position in the picking sequence that was output by the generative model.

7. The method of claim 1, wherein generating the item-to-item distance matrix for the list of items comprises:
determining that a specific item of the plurality is not associated with at least one bin by the computing system;
applying a generative model to a prompt including a set of items included in the location data, the specific item, the mapping of items available from the facility to bins, and an instruction to select an item nearest to the specific item;
generating a bin mapped to the item selected by the generative model; and
obtaining bin-to-bin distances for each pair of the specific item and other items of the list, a bin-to-bin distance for a pair of the specific item and an item of the list comprising a bin-to-bin distance between the bin mapped to the item selected by the generative model and a bin including the item of the list.

8. The method of claim 1, wherein obtaining the location data comprises identifying a latitude and a longitude as a physical location of an item within the facility.

9. The method of claim 1, further comprising:
transmitting the picking sequence to a client device of a person obtaining the list of items from the facility.

10. The method of claim 1, wherein generating the starting location within the facility and the ending location within the facility comprises:
generating the starting location as a bin including a physical location identified by the location data as an entrance to the facility; and
generating the ending location as an additional bin including a physical location identified by the location data as a checkout location within the facility.

11. A computer program product comprising a non-transitory computer readable storage medium having instructions encoded thereon that, when executed by a processor, cause the processor to perform steps comprising:
obtaining, at an online system, location data identifying physical locations within a facility of items available from the facility;
segmenting the location data into a plurality of bins, each bin representing a physical area in the facility;
mapping each item available from the facility to a corresponding bin based on the location data for each item and the plurality of bins;
generating a bin-to-bin distance for each pair of bins based on the location data;
storing the bin-to-bin distance for each pair of bins;
receiving a list of items to obtain from the facility at the online system;
generating a starting location within the facility and an ending location within the facility;
generating an item-to-item distance matrix for the list of items, the item-to-item distance matrix including a bin-to-bin distance for each pair of items of the list of items, the bin-to-bin distance for an item and an additional item comprising a stored bin-to-bin distance for a bin including the item and a bin including the additional item; and
generating a picking sequence for obtaining the list of items based on the item-to-item distance matrix based on the item-to-item distance matrix, the starting location, and the ending location, the picking sequence specifying an order to obtain the items of the plurality that minimizes a total distance traveled within the facility from the starting location to the ending location while obtaining each of the list of items.

12. The computer program product of claim 11, wherein generating the bin-to-bin distance for each pair of bins based on the location data comprises:
generating a two-dimensional coordinate system, with each bin corresponding to a coordinate pair in the two-dimensional coordinate system; and
generating a bin-to-bin distance for a pair of bins as a Manhattan distance based on a coordinate pair for a bin of the pair and a coordinate pair for another bin of the pair.

13. The computer program product of claim 11, wherein one or more bins are identified as being unable to be traversed by a person, and wherein the bin-to-bin distance for a pair of bins based on the location data comprise a path between a bin of the pair and another bin of the pair that avoids one or more bins identified as being unable to be traversed by the person.

14. The computer program product of claim 13, wherein generating the bin-to-bin distance for each pair of bins based on the location data comprises:
generating a two-dimensional coordinate system, with each bin corresponding to a coordinate pair in the two-dimensional coordinate system; and
generating a bin-to-bin distance for a pair of bins as a product of a multiplier based on a number of bins between a bin of the pair and an additional bin of the pair identified as unable to be traversed by a person and a Manhattan distance based on a coordinate pair for the bin of the pair and a coordinate pair for the additional bin of the pair.

15. The computer program product of claim 11, wherein generating the picking sequence for obtaining the list of items based on the item-to-item distance matrix comprises:
determining that a specific item of the plurality is not associated with at least one bin by the online system;
applying a generative model to a prompt including the picking sequence, the specific item, and an instruction to place the specific item in the picking sequence; and
generating the picking sequence so the specific item has a position in the picking sequence that was output by the generative model.

16. The computer program product of claim 11, wherein generating the item-to-item distance matrix for the list of items comprises:
determining that a specific item of the plurality is not associated with at least one bin by the online system;
applying a generative model to a prompt including a set of items included in the location data, the specific item, the mapping of items available from the facility to bins, and an instruction to select an item nearest to the specific item;
generating a bin mapped to the item selected by the generative model; and
obtaining bin-to-bin distances for each pair of the specific item and other items of the list, a bin-to-bin distance for a pair of the specific item and an item of the list comprising a bin-to-bin distance between the bin mapped to the item selected by the generative model and a bin including the item of the list.

17. The computer program product of claim 11, wherein obtaining the location data comprises identifying a latitude and a longitude as a physical location of an item within the facility.

18. The computer program product of claim 11, wherein the non-transitory computer readable storage medium further has instructions encoded thereon that, when executed by the processor, cause the processor to perform steps comprising:
transmitting the picking sequence to a client device of a person obtaining the list of items from the facility.

19. The computer program product of claim 11, wherein generating the starting location within the facility and the ending location within the facility comprises:
generating the starting location as a bin including a physical location identified by the location data as an entrance to the facility; and
generating the ending location as an additional bin including a physical location identified by the location data as a checkout location within the facility.

20. A system comprising:
a processor; and
a non-transitory computer readable storage medium having instructions encoded thereon that, when executed by the processor, cause the processor to perform steps comprising:
obtaining, at an online system, location data identifying physical locations within a facility of items available from the facility;
segmenting the location data into a plurality of bins, each bin representing a physical area in the facility;
mapping each item available from the facility to a corresponding bin based on the location data for each item and the plurality of bins;
generating a bin-to-bin distance for each pair of bins based on the location data;
storing the bin-to-bin distance for each pair of bins;
receiving a list of items to obtain from the facility at the online system;
generating a starting location within the facility and an ending location within the facility;
generating an item-to-item distance matrix for the list of items, the item-to-item distance matrix including a bin-to-bin distance for each pair of items of the list of items, the bin-to-bin distance for an item and an additional item comprising a stored bin-to-bin distance for a bin including the item and a bin including the additional item; and
generating a picking sequence for obtaining the list of items based on the item-to-item distance matrix based on the item-to-item distance matrix, the starting location, and the ending location, the picking sequence specifying an order to obtain the items of the plurality that minimizes a total distance traveled within the facility from the starting location to the ending location while obtaining each of the list of items.
